(19) United States
(12) Patent Application Publication
(10) Pub. No.: US 2021/0276034 A1
(43) Pub. Date: Sep. 9, 2021

(54) APERTURE PLATE STRUCTURE AND APPLICATIONS THEREOF

(71) Applicant: TAIWAN PURITIC CORP., Hsinchu County (TW)

(72) Inventors: Chih-Hsien CHOU, Hsinchu County (TW); Huan-Ping TENG, Hsinchu County (TW); Chih-Hsiang HSU, Hsinchu County (TW)

(73) Assignee: TAIWAN PURITIC CORP.

(21) Appl. No.: 17/031,445

(22) Filed: Sep. 24, 2020

(30) Foreign Application Priority Data
Mar. 4, 2020 (TW) 109106995

(51) Int. Cl. B05B 17/00; B05B 17/06

(52) U.S. Cl. CPC B05B 17/0646; B05B 17/0669

(57) ABSTRACT

The present invention discloses an aperture plate and an aerosol generator. The aperture plate is made by metal materials with a plurality of apertures. The aperture plate has a multi-layer structure, which comprises a substrate, a protective layer and/or at least one intermediate layer between the substrate and the protective layer. The intermediate layer is configured to enhance the adhesion between the substrate and the protective layer, so that it can increase the durability of the aperture plate. The aperture plate can be a dome-shaped, a flat-shaped or an irregular shape. The aperture plate of the present invention can optimize the volume and size of droplets under the vibration at certain frequency.

### BACKGROUND OF THE INVENTION

### 1. Field of the Invention

The present invention relates to an aperture plate, which can be applied to an aerosol generator. In particular, the aperture plate includes a multilayer or an arc-shaped structure.

### 2. Description of the Prior Art

A general aerosol generator or an atomizer uses an aperture plate, which can be vibrated by a vibrator, and droplets are generated after liquid passes through the vibrating aperture plate.

However, the aperture plate is prone to deformation or cracks by vibration for a usage period. If the aperture plate is too soft to a determined amplitude, it cannot reach the desired atomization effect, and the aperture plate are easily corroded by an acidic or alkaline solution. The above factors and the physical and chemical characteristics of the solution shorten the lifetime and restrict its application of the aperture plate.

In addition, in general the aperture plate is made of a nickel-palladium alloy with a ratio of 20:80, wherein the nickel component may cause allergies and the palladium is expensive.

### SUMMARY OF THE INVENTION

In order to improve above problem, the present invention provides an aperture plate, which is a plate having a plurality of apertures, and the aperture plate has a diameter ranging from 1 μm to 20 ∞m. The aperture plate comprises a substrate and a protective layer coated on the substrate. The substrate is a metal, an alloy, a polymer plastic or their combination, and the protective layer is a metal, an alloy, a carbide, a nitride, a metal oxide, a fluorine-containing plastic, an imide-containing plastic, a polyamide-containing plastic or their combination.

The layered aperture plate of the present invention can avoid or reduce deformation by vibration, the protective layer material protects the aperture plate from being corroded by acidic and alkaline solution. Comparison to the conventional aperture plate, the layered aperture plate elongates the lifetime, extends the application scope, reduces the cost and reduces the allergies caused by heavy metal.

Below, the embodiments accompanied with the attached drawings are employed to explain the objectives, technical contents, characteristics and accomplishments of the present invention.

### BRIEF DESCRIPTION OF THE DRAWINGS

FIG. 1 shows part of a side cross-sectional view of the aperture plate of the present invention.

FIG. 2 shows the detail of the inner aperture of the aperture plate shown in FIG. 1.

FIG. 3 is a side view to show the design structure of the aperture plate according to another embodiment of the present invention.

### DESCRIPTION OF THE PREFERRED EMBODIMENTS

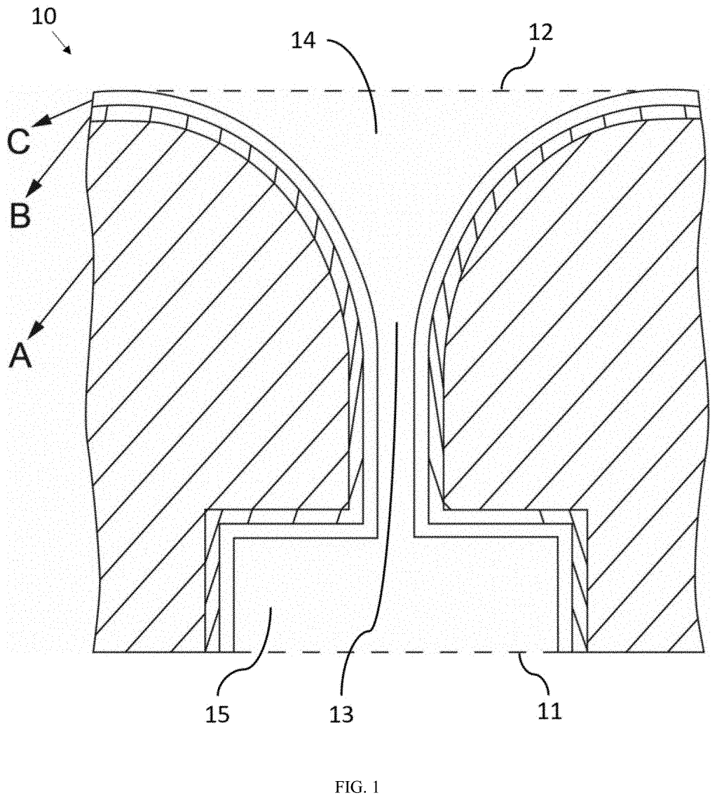

As shown FIG. 1, the aperture plate 10 of the present invention has a multilayer structure, including at least a substrate A and a protective layer C, coated on the substrate A. The substrate A, made by metal or polymer plastic material, provides a required hardness. The protective layer, made by metal, carbide or plastic, protects the substrate A from corrosion and avoid the substrate A, which might incur allergic reaction, touching the user. In addition, at least one intermediate layer B can be layered between the protective layer C and the substrate A to increase the adhesion.

An embodiment of the layered porous plate 10 is shown as FIG. 1. The substrate A is made by metal, alloy or polymer plastic materials, such as carbon-containing metals (such as stainless steel), nickel, titanium, nickel alloy, cobalt alloy, copper alloy, titanium alloy, polyethylene (PE), polypropylene (PP), polyimide (PI), aromatic polyamide (Kevlar) or a combination thereof. In one embodiment, the substrate is made by nickel-cobalt alloy, which has a high hardness and is not easily deformed.

The protective layer C, coated on the substrate A, is made by metal, alloy, metal oxide, carbide, nitride, fluorine-containing plastic, amide-containing plastic or polyamide (PA), such as palladium, gold, platinum, iridium, silver, indium, rhodium, ruthenium, palladium nickel alloy, Teflon, titanium nitride, chromium nitride, aluminum nitride, aluminum oxide, silicon carbide, polyimide (PI), aromatic polyamide (Kevlar) or their combination. The thickness of the protective layer C varies 0.5 μm to 100 μm. In one embodiment, the protective layer C is made by palladium, which can avoid allergies.

In a preferred embodiment, the aperture plate 10 further comprises at least one intermediate layer B, which is made by metal or alloy, such as nickel, nickel-palladium, nickel-phosphorus or their combination. The layer B is an intermediate layer, disposed between the substrate A and the protective layer C, to increase the layered adhesion. The thickness of the intermediate layer B varies from 0.05 μm to 60 μm. In one embodiment, the layer B has a thickness 0.1 μm. In one embodiment, the layered is made by nickel metal, which can improve the adhesion of the protective layer and the nickel-cobalt substrate.

The aperture plate 10 has a plurality of apertures with diameter ranging from 1 μm to 20 μm. Each of the plurality of apertures has an outlet 13, the outer part of the plurality of apertures, and the inner part defines an inlet 14. The solution or liquid enters the inlet 13, through the inlet 14, and then exit.

In one embodiment, the outlet 13 is shaped to be a cylindrical cone shown as the rectangular portion 15, and the inlet 14 is a flared cone.

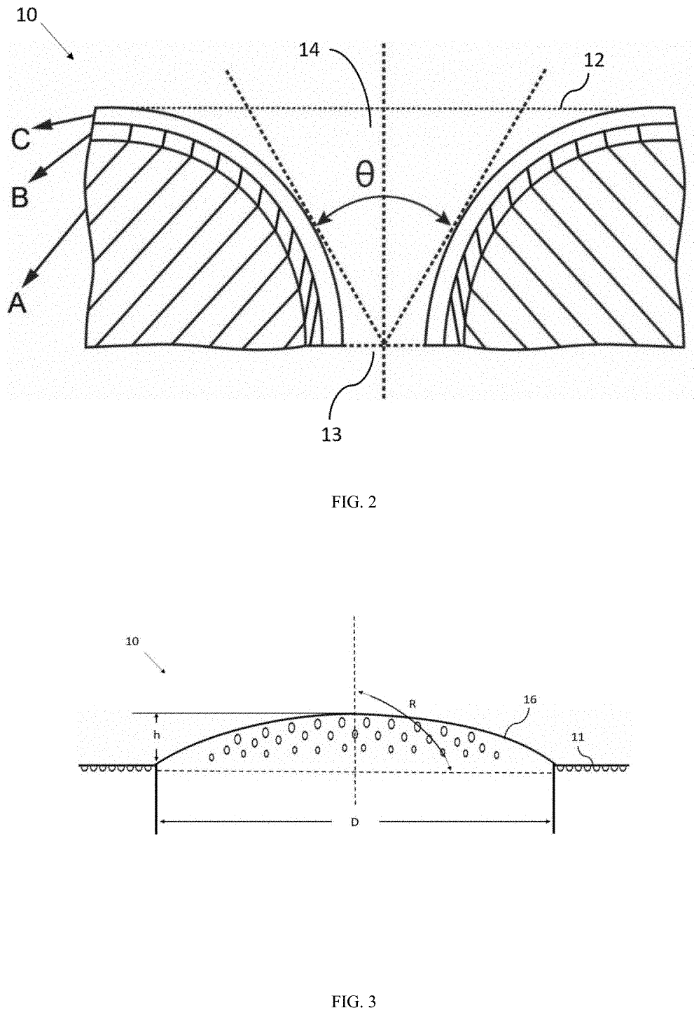

FIG. 2 shows the detailed of the inlet 14 of the embodiment FIG. 1.

The flared inlet 14 of each of the plurality of apertures has a solid angle θ of 15° to 75°, where the cone pin is defined at the neck of the plurality of apertures as shown in FIG. 2. In a preferred embodiment, the solid angle θ is 45° and that may have a maximized droplet volume and an optimized droplet size.

FIG. 3 shows a side view of the aperture plate according to an embodiment of the present invention. In this embodiment, the aperture plate 10 has at least one arc convex portion 16 with a height h and a diameter D. In general, the ratio of the height to the radius(D/2) is 0.01-2. The arc convex portion 16 can be disposed at any position. In this embodiment, the arc convex portion 16 is set at the center. The arc convex portion 16 may also be shaped another arc convex or irregular convex even. In one embodiment, the arc convex portion 16 is an elliptical convex shape. In a preferred embodiment, the arc convex portion 16 has an external arc angle R, which is a ¼ circle (90°), and a value of the external arc angle R is a length of radius, i.e. R2.0 means its radius is 2.0 mm. The value of the external arc angle R may be R1.0 to R5.0, preferably R3.0.

The solution or liquid can be cut into discrete droplets when passing the vibrating aperture plate 10. The vibration frequency is related to the thickness of the aperture plate 10 and the physical and chemical properties of the solution or liquid. In one embodiment, the vibration frequency of 103-160 kilohertz (kHz) generates a better spray effect for the aperture plate with a nickel-cobalt substrate and a palladium protective layer. In another embodiment, the vibration frequency 108 kHz is better for the aperture plate 10 with thickness 25-100 μm.

In summary, the aperture plate of the present invention is designed to a multilayer structure, a substrate and a protective layer. An arc convex may be disposed on the aperture layer. One or more intermediate layers may be used to strengthen the adhesion. The aperture plate can spray better droplets under specific frequency vibration. The aperture plate has a better anti-vibration property and has an anti-corrosion property because the hardness substrate and the protective layer, so it can extend the usage life, expand application scope, reduce the cost and avoid allergic reaction caused by heavy metal.

The embodiments described above are merely illustrative of the technical spirit and features of the present invention, and they are intended to enable those skilled in the art to understand the present invention and practice the present invention. The scope of the patent, that is, the equivalent changes or modifications made by the spirit of the present invention, should still be included in the scope of the patent of the present invention.

What is claimed is:

1. An aperture plate with a plurality of apertures, which the plurality of apertures has an aperture diameter ranging from 1 μm to 20 μm, comprising:
a substrate and a protective layer coated on substrate, wherein the substrate is made by a metal, an alloy, a polymer plastic or their combination; and
the protective layer is made by s a metal, an alloy, a carbide, a nitride, a metal oxide, a fluorine-containing plastic, an imide-containing plastic, a polyamide (PA)-containing plastic or their combination.

2. The aperture plate of claim 1, wherein the substrate is made by carbon-containing metal, nickel, titanium, nickel alloy, cobalt alloy, copper alloy, titanium alloy, polyethylene (PE), polypropylene (PP), polyimide (PI), aromatic polyamide (Kevlar) or their combination.

3. The aperture plate of claim 1, wherein the protective layer is made by palladium, gold, platinum, iridium, silver, indium, rhodium, ruthenium, palladium nickel alloy, Teflon, titanium nitride, chromium nitride, aluminum nitride, aluminum oxide, silicon carbide, poly imidine (PI), aromatic polyamide (Kevlar) or their combination.

4. The aperture plate of claim 1, wherein a thickness of the protective layer is 0.5 μm to 100 μm.

5. The aperture plate of claim 1, further comprising at least one intermediate layer between the substrate and the protective layer, wherein the intermediate layer is made by a metal and has a thickness ranging from 0.05 μm to 60 μm.

6. The aperture plate of claim 5, wherein the intermediate layer is made by nickel, nickel-palladium, nickel-phosphorus or their combination.

7. The aperture plate of claim 1, wherein an inlet is defined as the inner part of the plurality of apertures and the inlet has a solid angle between 15° and 75°.

8. The aperture plate of claim 1, wherein at least one arc convex portion is disposed on the aperture plate, and a ratio of height to radius of the arc convex portion is 0.01-2.

9. An aerosol generator comprising an aperture plate of claim 1 and a vibrator, wherein the vibrator drives the aperture plate vibrate at a frequency of 103 to 160 kilohertz (kHz) to generate droplets.
